(19) United States
(12) Patent Application Publication
(10) Pub. No.: US 2024/0025537 A1
(43) Pub. Date: Jan. 25, 2024

(54) FIXED-WING AIRCRAFT WITH VARIABLE-VOLUME BUOYANT BAGS

(71) Applicant: Raytheon BBN Technologies Corp., Cambridge, MA (US)

(72) Inventors: James Joseph Stusse, Middletown, RI (US); Benjamin Jacob Rosenthal, Newport, RI (US)

(21) Appl. No.: 17/869,067

(22) Filed: Jul. 20, 2022

(51) Int. Cl. B64C 25/56; B64D 27/26; B64F 5/10

(52) U.S. Cl. CPC B64C 25/56; B64D 27/26; B64F 5/10; B64C 39/024

(57) ABSTRACT

A system in a fixed-wing aircraft includes inflatable buoyant bags. Each of the inflatable buoyant bags is arranged to conformally cover a corresponding pylon attachment of the fixed-wing aircraft in a deflated state. The system also includes a tank storing pressurized gas and a controller to control inflow of the pressurized gas from the tank into the inflatable buoyant bags to increase buoyancy of the fixed-wing aircraft and to control outflow of the pressurized gas out of the inflatable buoyant bags to decrease buoyancy of the fixed-wing aircraft.

### BACKGROUND

The present disclosure relates to fixed-wing aircraft and, in particular, to fixed-wing aircraft with variable-volume buoyant bags.

Fixed-wing aircraft (e.g., manned, unmanned) are typically jet or propeller driven. These aircraft are maneuverable, but their flight duration is limited by their fuel efficiency. Airships (e.g., blimps) and balloons rely on buoyancy and can support long flights but are not maneuverable or as fast as fixed-wing aircraft. A hybrid plane-airship has been developed with fixed volume buoyant bags. The hybrid aircraft allow increased flight duration but suffer from the lack of maneuverability of airships and exhibit lower performance in atmospheric winds.

### SUMMARY

According to one embodiment, a system in a fixed-wing aircraft includes inflatable buoyant bags. Each of the inflatable buoyant bags is arranged to conformally cover a corresponding pylon attachment of the fixed-wing aircraft in a deflated state. The system also includes a tank storing pressurized gas and a controller to control inflow of the pressurized gas from the tank into the inflatable buoyant bags to increase buoyancy of the fixed-wing aircraft and to control outflow of the pressurized gas out of the inflatable buoyant bags to decrease buoyancy of the fixed-wing aircraft.

In accordance with additional or alternative embodiments, the system also includes a pressure regulator to regulate pressure of the pressurized gas from the tank before the pressurized gas is supplied to one of the inflatable buoyant bags.

In accordance with additional or alternative embodiments, the pressurized gas is hydrogen.

In accordance with additional or alternative embodiments, the pressurized gas is helium.

In accordance with additional or alternative embodiments, two of the inflatable buoyant bags are arranged to conformally cover two corresponding pylon attachments.

In accordance with additional or alternative embodiments, the pylon attachments are affixed to tips of each of two wings of the fixed-wing aircraft.

In accordance with additional or alternative embodiments, the controller determines whether the inflow or the outflow of the pressurized gas is needed based on a current state of inflation of the inflatable buoyant bags and a desired state of inflation of the inflatable buoyant bags.

In accordance with additional or alternative embodiments, the controller obtains the desired state of inflation of the inflatable buoyant bags as an input.

In accordance with additional or alternative embodiments, the controller determines the desired state of inflation of the inflatable buoyant bags based on an input of a flight mode.

In accordance with additional or alternative embodiments, the fixed-wing aircraft is manned or unmanned.

According to another embodiment, a method of assembling a system in a fixed-wing aircraft includes arranging inflatable buoyant bags such that each of the inflatable buoyant bags conformally covers a corresponding pylon attachment of the fixed-wing aircraft in a deflated state. The method also includes storing pressurized gas in a tank of the fixed-wing aircraft and configuring a controller to control inflow of the pressurized gas from the tank into the inflatable buoyant bags to increase buoyancy of the fixed-wing aircraft and to control outflow of the pressurized gas out of the inflatable buoyant bags to decrease buoyancy of the fixed-wing aircraft.

In accordance with additional or alternative embodiments, the method also includes arranging a pressure regulator to regulate pressure of the pressurized gas from the tank before the pressurized gas is supplied to one of the inflatable buoyant bags.

In accordance with additional or alternative embodiments, the storing the pressurized gas includes storing hydrogen.

In accordance with additional or alternative embodiments, the storing the pressurized gas includes storing helium.

In accordance with additional or alternative embodiments, the arranging the inflatable buoyant bags includes arranging two of the inflatable buoyant bags to conformally cover two corresponding pylon attachments.

In accordance with additional or alternative embodiments, the pylon attachments are affixed to tips of each of two wings of the fixed-wing aircraft.

In accordance with additional or alternative embodiments, the configuring the controller includes the controller determining whether the inflow or the outflow of the pressurized gas is needed based on a current state of inflation of the inflatable buoyant bags and a desired state of inflation of the inflatable buoyant bags.

In accordance with additional or alternative embodiments, the configuring the controller includes the controller obtaining the desired state of inflation of the inflatable buoyant bags as an input.

In accordance with additional or alternative embodiments, the configuring the controller includes the controller determining the desired state of inflation of the inflatable buoyant bags based on an input of a flight mode.

In accordance with additional or alternative embodiments, the fixed-wing aircraft is manned or unmanned.

Additional features and advantages are realized through the techniques of the present disclosure. Other embodiments and aspects of the disclosure are described in detail herein and are considered a part of the claimed disclosure. For a better understanding of the disclosure with the advantages and the features, refer to the description and to the drawings.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIG. 1 is a block diagram of a fixed-wing aircraft with variable-volume buoyant bags according to one or more embodiments;

FIG. 2 illustrates different levels of inflation for buoyant bags of a fixed-wing aircraft with variable-volume buoyant bags according to one or more embodiments;

FIG. 3 shows a fixed-wing aircraft with variable-volume buoyant bags according to an exemplary embodiment; and

FIG. 4 is a process flow of a method of controlling buoyancy in a fixed-wing aircraft with variable-volume buoyant bags according to one or more embodiments.

### DETAILED DESCRIPTION

As previously noted, fixed-wing aircraft generally are more maneuverable than airships but have a shorter flight duration. Prior approaches to a hybrid plane-airship have involved fixed volume buoyant bags. These hybrids suffer some of the disadvantages of fixed-wing aircraft and airships. Embodiments of the systems and methods detailed herein relate to a fixed-wing aircraft with variable-volume buoyant bags. Inflated volume of the variable-volume buoyant bags may be controlled to vary between full deflation and full inflation. Thus, based on the conditions, the aircraft may benefit from the performance of a typical fixed-wing aircraft, the buoyant lift of an airship, or a mix of the two.

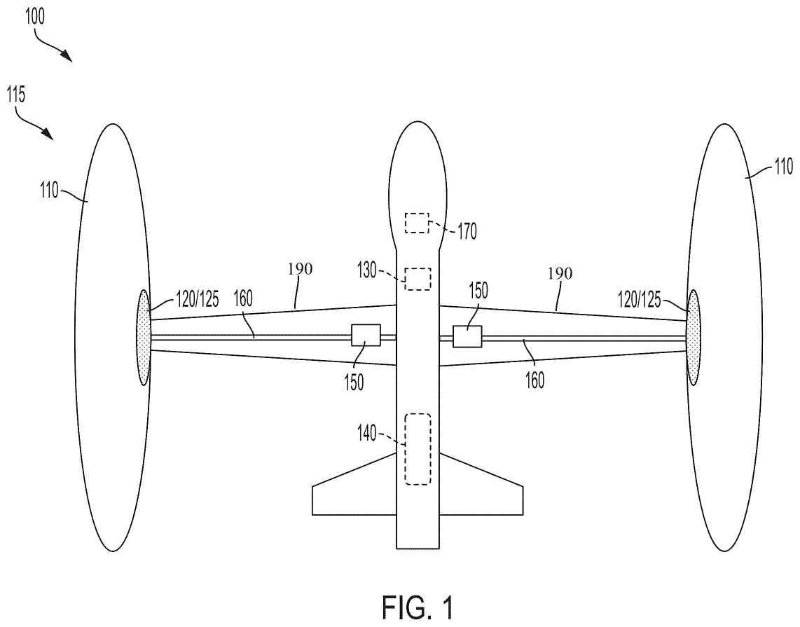

FIG. 1 is a block diagram of a fixed-wing aircraft 100 with variable-volume buoyant bags 110 of a variable-volume buoyancy system 1115 according to one or more embodiments. The exemplary illustration in FIG. 1 shows the buoyant bags 110 fully inflated. The buoyant bags 110 may be an elastic polymer or elastomeric bladder that is designed to withstand the mechanical and environmental requirements imposed by an aerospace application. As shown, each of the buoyant bags 110 is conformally inflated around a pylon 120 of the aircraft 100. The pylon 120 shown in FIG. 1 is a wingtip pylon 125 located at the tip of the wings of the aircraft 100. The pylon 120 refers to an adapter attached to the aircraft 100 to connect the frame of the aircraft 100 to an item being carried, which is the buoyant bag 110 in this case. Inflation of the buoyant bags 110 results from the supply of pressurized gas (e.g., hydrogen, helium) from a tank 140 via supply lines 160 into each of the buoyant bags 110. Pressure regulators 150 may measure and regulate pressure of the gas in the supply lines 160. The aircraft 100 of FIG. 1 is shown with a payload 170 (e.g., battery).

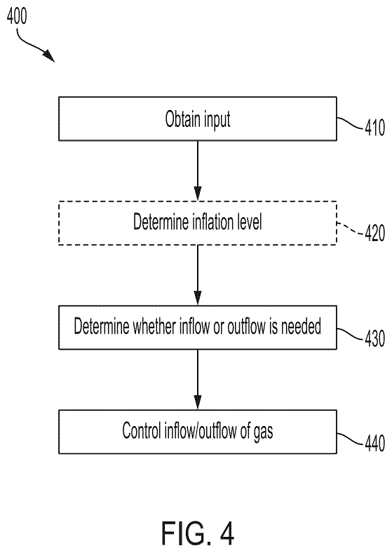

A controller 130 is also shown in FIG. 1. In alternate embodiments, the pressure regulators 150 may implement the functions discussed with reference to the controller 130, thereby eliminating the need for a separate controller 130. In other alternate embodiments, the pressure regulators 150 may control the level of inflation of the buoyant bags 110 in combination with the controller 130. The controller 130 may receive input that indicates the level of inflation needed for the buoyant bags 110 or may receive information (e.g., flight mode) used by the controller 130 to determine a level of inflation. That is, the controller 130 may map the information to a level of inflation, for example. This is further discussed with reference to FIG. 4. When deflation of the buoyant bags 110 is required, some or all of the pressurized gas in the buoyant bags 110 may be expelled from the aircraft 100 or may be recaptured (e.g., into a separate tank).

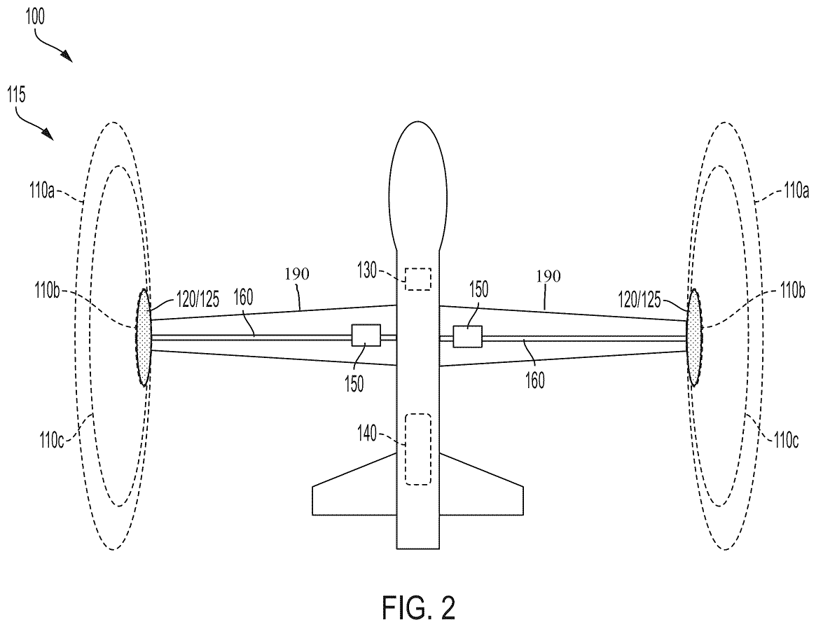

FIG. 2 illustrates different levels of inflation for buoyant bags 110 of a fixed-wing aircraft 100 with variable-volume buoyant bags 110 according to one or more embodiments. The fully inflated buoyant bags 110 are labeled as 110a and are like those shown in FIG. 1. Completely deflated buoyant bags 110 are labeled as 110b. As shown, the fully deflated buoyant bags 110b conformally cover (i.e., cling to) the wingtip pylons 120. Based on control of the inflow/outflow of pressurized gas into/out of the buoyant bags 110 by the controller (and/or pressure regulators 150), the buoyant bags 110 may be inflated/deflated to a level between fully inflated (i.e., buoyant bags 110a) and fully deflated (i.e., buoyant bags 110b). Exemplary buoyant bags 110c in FIG. 2 illustrate this in-between inflation level.

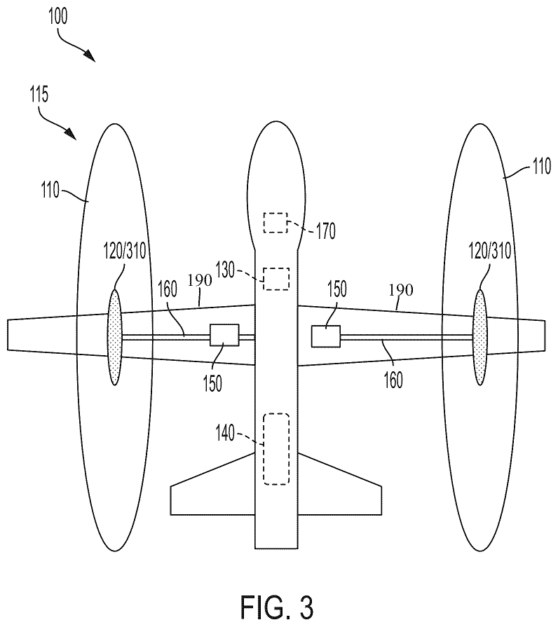

FIG. 3 shows a fixed-wing aircraft 100 with variable-volume buoyant bags 110 according to an exemplary embodiment. In the exemplary embodiment of FIG. 3, the pylons 120 are mid-wing pylons 310. The wingtip pylons 125 of FIG. 1 and the mid-wing pylons 310 of FIG. 3 illustrate two exemplary locations for the pylons 120 and the buoyant bags 110 that conformally inflate/deflate around them. These two examples are not intended to limit other locations for the pylons 120 and buoyant bags 110 around the aircraft 100. Regardless of the location, the buoyant bags 110 may be controlled for different levels of inflation, as shown in FIG. 2. When fully deflated, each of the buoyant bags 110 may conformally surround (i.e., cling to) the associated pylon 120.

FIG. 4 is a process flow of a method 400 of controlling buoyancy in a fixed-wing aircraft 100 with variable-volume buoyant bags 110 according to one or more embodiments. The processes may be performed by the controller 130, the pressure regulators 150, or a combination of the two and may be implemented by one or more processors processing instructions that are stored in one or more memory devices (i.e., non-transitory computer readable media). At block 410, obtaining input may refer to the input of a level of inflation for the buoyant bags 110. In this case, the process at block 420 may be omitted. The input indicating a level of inflation may come from another controller of the aircraft 100, a pilot (in the case of a manned aircraft 100), or via communication from outside the aircraft (e.g., in an unmanned aircraft 100), for example.

At block 410, obtaining the input may, instead, refer to obtaining a flight mode (e.g., fully-buoyant lift, steady flight (or glide), wind hovering, loitering descent) or other information that does not directly indicate inflation level for the buoyant bags 110. This input (e.g., flight mode) may be used, at block 420, to determine a corresponding inflation level. For example, fully-buoyant lift requires full inflation (i.e., buoyant bags 110a). An input mode of steady flight requires full deflation (i.e., buoyant bags 110b). Wind hovering mode requires partially inflated buoyant bags 110c and balancing of wing and buoyant lift against wind. Loitering descent may require partial or no inflation of the buoyant bags 110.

At block 430, the processes include determining whether inflow or outflow of pressurized gas is needed. That is, the desired inflation level, which is obtained as input at block 410 or determined at block 420, is compared with the current inflation level of the buoyant bags 110 to determine whether pressurized gas must be added to or removed from the buoyant bags 110 to achieve the desired level of inflation. Once the determination is made, at block 430, of whether inflow or outflow is needed, the needed inflow or outflow of pressurized gas is controlled at block 440. If deflation is needed, the gas expelled from the buoyant bags 110 may be recaptured, as previously noted.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form detailed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the various embodiments with various modifications as are suited to the particular use contemplated.

While the preferred embodiments have been described, it will be understood that those skilled in the art, both now and in the future, may make various improvements and enhancements which fall within the scope of the claims which follow. These claims should be construed to maintain the proper protection for the disclosure as first described.

1. A system in a fixed-wing aircraft comprising:
fixed wings;
inflatable buoyant bags, each of the inflatable buoyant bags being arranged to conformally cover a corresponding pylon attachment on the fixed wings of the fixed-wing aircraft in a deflated state;
a tank storing pressurized gas; and
a controller configured to control inflow of the pressurized gas from the tank into the inflatable buoyant bags to increase buoyancy of the fixed-wing aircraft and to control outflow of the pressurized gas out of the inflatable buoyant bags to decrease buoyancy of the fixed-wing aircraft.

2. The system according to claim 1, further comprising a pressure regulator configured to regulate pressure of the pressurized gas from the tank before the pressurized gas is supplied to one of the inflatable buoyant bags.

3. The system according to claim 1, wherein the pressurized gas is hydrogen.

4. The system according to claim 1, wherein the pressurized gas is helium.

5. The system according to claim 1, wherein two of the inflatable buoyant bags are arranged to conformally cover two corresponding pylon attachments.

6. The system according to claim 5, wherein the pylon attachments are affixed to tips of each of two fixed wings of the fixed-wing aircraft.

7. The system according to claim 1, wherein the controller is configured to determine whether the inflow or the outflow of the pressurized gas is needed based on a current state of inflation of the inflatable buoyant bags and a desired state of inflation of the inflatable buoyant bags.

8. The system according to claim 7, wherein the controller is configured to obtain the desired state of inflation of the inflatable buoyant bags as an input.

9. The system according to claim 7, wherein the controller is configured to determine the desired state of inflation of the inflatable buoyant bags based on an input of a flight mode.

10. The system according to claim 1, wherein the fixed-wing aircraft is manned or unmanned.

11. A method of assembling a system in a fixed-wing aircraft, the method comprising:
arranging inflatable buoyant bags such that each of the inflatable buoyant bags conformally covers a corresponding pylon attachment on fixed wings of the fixed-wing aircraft in a deflated state;
storing pressurized gas in a tank of the fixed-wing aircraft; and
configuring a controller to control inflow of the pressurized gas from the tank into the inflatable buoyant bags to increase buoyancy of the fixed-wing aircraft and to control outflow of the pressurized gas out of the inflatable buoyant bags to decrease buoyancy of the fixed-wing aircraft.

12. The method according to claim 11, further comprising arranging a pressure regulator to regulate pressure of the pressurized gas from the tank before the pressurized gas is supplied to one of the inflatable buoyant bags.

13. The method according to claim 11, wherein the storing the pressurized gas includes storing hydrogen.

14. The method according to claim 11, wherein the storing the pressurized gas includes storing helium.

15. The method according to claim 11, wherein the arranging the inflatable buoyant bags includes arranging two of the inflatable buoyant bags to conformally cover two corresponding pylon attachments.

16. The method according to claim 15, wherein the pylon attachments are affixed to tips of each of two fixed wings of the fixed-wing aircraft.

17. The method according to claim 11, wherein the configuring the controller includes the controller determining whether the inflow or the outflow of the pressurized gas is needed based on a current state of inflation of the inflatable buoyant bags and a desired state of inflation of the inflatable buoyant bags.

18. The method according to claim 17, wherein the configuring the controller includes the controller obtaining the desired state of inflation of the inflatable buoyant bags as an input.

19. The method according to claim 17, wherein the configuring the controller includes the controller determining the desired state of inflation of the inflatable buoyant bags based on an input of a flight mode.

20. The method according to claim 11, wherein the fixed-wing aircraft is manned or unmanned.
